(19) United States
(12) Patent Application Publication
(10) Pub. No.: US 2011/0263369 A1
(43) Pub. Date: Oct. 27, 2011

(54) CHAIN

(75) Inventor: Kazuyoshi Kurihara, Osaka (JP)

(73) Assignee: TSUBAKIMOTO CHAIN CO.,, Osaka (JP)

(21) Appl. No.: 13/079,082

(22) Filed: Apr. 4, 2011

(30) Foreign Application Priority Data
Apr. 26, 2010 (JP) 2010-100983

(51) Int. Cl. F16G 13/06

(52) U.S. Cl. 474/206

(57) ABSTRACT

In a chain comprising interconnected link plates at least some of which come into sliding contact with one or more chain guides, at least some of the link plate edges that come into sliding contact with the guides have a convex curvature with different curvatures on the front and rear sides of an apex at an intermediate location. The radius of curvature on the front side of the apex is greater than the radius of curvature on the rear side of the apex. The front and rear curvatures can be circular or cycloidal. Alternatively, one of the front and rear portions can be circular while the other is cycloidal.

### CROSS REFERENCE TO RELATED APPLICATIONS

This application claims priority on the basis of Japanese Patent Application 2010-100983, filed on Apr. 26, 2010. The disclosure of Japanese Patent Application 2010-100983 is incorporated by reference.

### FIELD OF THE INVENTION

The invention relates to a low-friction chain for use in a power transmission mechanism. The low-friction chain has utility in various kinds of industrial machinery, including carrying machines and the like, and is particularly suited for use as a timing chain in an automobile engine.

### BACKGROUND OF THE INVENTION

When a chain is used in a power transmission mechanism, the chain is typically engaged in driven relationship with a driving sprocket and in driving relationship with one or more driven sprockets. For instance, in the timing drive of an automobile engine, the timing chain is engaged with and driven by a crankshaft sprocket, and engaged in driving relationship with one or more camshaft sprockets. The chain typically moves in sliding contact with one or more guide members, such as a stationary guide or a pivoted tensioner lever.

The chain is usually composed of a plurality of link plates each having a pair of pin holes. The link plates are arranged in groups of two or more link plates in side-by-side, spaced, relationship, the groups of plates being interleaved with one another and connected to form a flexible, endless chain by connecting pins inserted through the pin holes of the link plates. Edges of the link plate are formed so that they can slide on the guide members.

In order to reduce sliding-contact resistance between the end edge of the link plate and the guide member, it is known to form the guide-contacting edges of the link plates with a convex curvature in order to reduce the sliding contact area, and to allow lubricant to generate dynamic pressure. An example of a chain having link plates with convex guide-engaging edges is disclosed in United States Patent Application Publication 2008/0020882, by T. Tohara et al., published Jan. 24, 2008.

As shown in FIG. 6, of this application, this known chain 500 has pairs of inner and outer link plates 510 and 520, connected in interleaved relationship by connecting pins 530, which are fixed to the outer plates 510, and extend rotatably through bushings 540, which are fixed to the inner plates 520. The link plates 510 and 520 have convex edges 511 and 521, for sliding contact with a guide. As the chain travels in sliding contact with a guide, only apex portions of edges 511 and 521, i.e., portions which are farthest from an imaginary line through the centers of the connecting pins, contact the guide. Therefore, the sliding contact area is reduced, and, as the chain travels over the guide, wedge-like spaces forward of the areas of the plates that contact the guide are filled with lubricant, reducing sliding contact resistance by causing a wedge film effect, Couette flow, and dynamic pressure in the lubricant.

In the known chain 500, because the respective link plates 510 and 520 are bilaterally symmetric, that is, they have the same curvature on the front and rear sides of the apices of their convex edges 511 and 521, the high surface pressure near the apex causes increased wear even though the sliding contact resistance is reduced by the wedge film effect.

If the radius of curvature of the front and rear sides of the apex of the convex edges 511 and 521 is increased to reduce the surface pressure in the vicinity of the apex and thereby overcome the abovementioned problem of excessive wear, lubricant contacts the convex edges 511 and 521 over large areas both ahead of and behind the apex, reducing the effectiveness of the wedge-film effect because of increased sliding contact resistance due to the viscosity of the lubricant.

### SUMMARY OF THE INVENTION

An aim of this invention is to address the aforementioned problems by providing a chain in which sliding contact resistance is more effectively reduced by reducing the sliding contact area and by generating dynamic pressure in the lubricant, and in which wear of the parts that come into sliding contact is also reduced.

The chain according to the invention is an elongated, low-friction transmission chain comprising a plurality of links flexibly interconnected by parallel connecting pins extending through front and rear pin holes in each of the plates. Each link comprises a plurality of link plates at least some of which have at least one edge for sliding contact with a guide member. That edge has a continuous convex curvature in a plane to which the connecting pins extend in perpendicular relationship. An apex of the edge is located at a position equidistant from centers of the front and rear pin holes of the plate. The convex edge has different curvatures on front and rear sides of the apex. The equidistant location of the apex and the different curvatures of edge on the front and rear sides of the apex make it possible to optimize the curvature of the front portion in order to generate Couette flow and to generate dynamic pressure in the lubricant, and at the same time to optimize the curvature of the rear portion independently to reduce the resistance caused by the viscosity of the lubricant. Thus, the different curvatures in front of and to the rear of the apex make it possible achieve an optimum reduction in sliding contact resistance and in the rate of wear of the sliding contact surfaces of the chain and the chain guides.

In a preferred embodiment of the invention, in which the edge of a link plate has a front portion ahead of the apex in relation to the direction of chain travel, and a rear portion behind the apex in relation to the direction of chain travel, the radius of curvature of the edge is greater in the front portion than in the rear portion. In this embodiment, the flow rate of the lubricant is faster at the front side from the apex and slower at the rear side, due to Couette flow. Accordingly, lubrication in the vicinity of the apex is improved, and the rate of wear is reduced. At the same time, because the gap between the convex edge and guide surface increases rapidly within a short distance on the rear side from the apex, sliding contact resistance caused by the viscosity of the lubricant is reduced.

The curvatures of both the front portion and the rear portion can be in the form of circular arcs, each having a constant radius, in which case design and fabrication of the asymmetrically shaped link plates is facilitated.

In a first alternative embodiment, the curvatures of both the front portion and the rear portion can be cycloidal. In this case, the radii of curvature both in front of and behind the apex are large, and the wedge-film effect is achieved more effectively, while the surface pressure is lowered. On the other hand, the radii of curvature decrease with increasing distance from the apex, and it becomes possible to shorten the area affected by the viscosity of the lubricant and thereby reduce sliding contact resistance.

In still another alternative embodiment, the curvature of one of the front and rear portions is in the form of a circular arc having a constant radius, and the curvature of the other of the front and rear portions is cycloidal. For example, if the front portion of the edge is in the form of a cycloid better advantage can be taken of the wedge film effect. On the other hand, if the rear portion of the edge is in the form of a cycloid, the sliding contact resistance caused by lubricant viscosity can be reduced. In either case, the design and fabrication of the link plate can be facilitated.

### BRIEF DESCRIPTION OF DRAWINGS

FIG. 1 is a schematic elevational view of an engine timing drive incorporating a chain according to the invention;

FIG. 2 is a side elevational view of a portion of a chain according to a first embodiment of the invention;

FIG. 3 is an enlarged side elevational view of a link plate of the chain of FIG. 2

FIG. 4 is a diagram explaining the operations of the chain according to the first embodiment;

FIG. 5 is a side elevational view of a portion of a chain according to a second embodiment of the invention; and

FIG. 6 is a perspective view of a portion of a prior art chain.

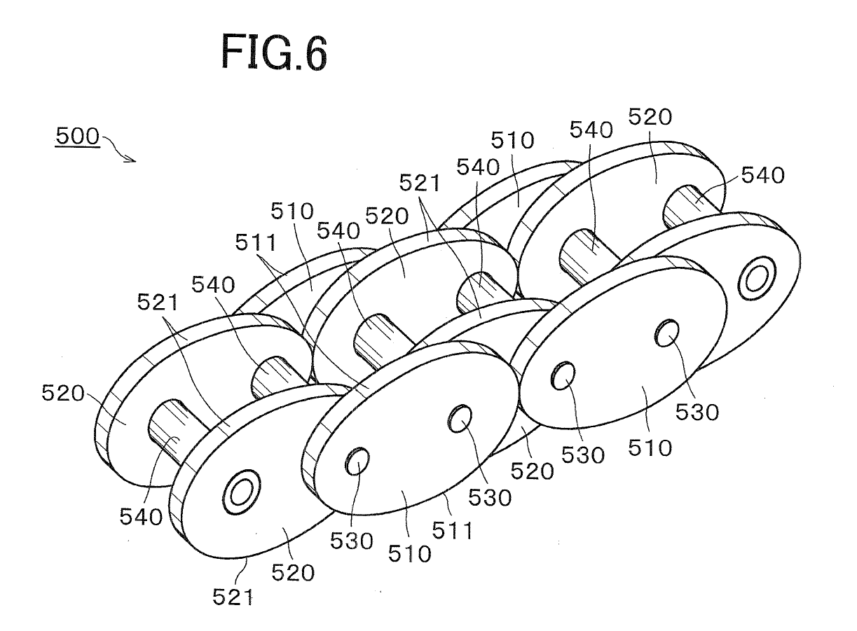

### DETAILED DESCRIPTION OF THE PREFERRED EMBODIMENTS

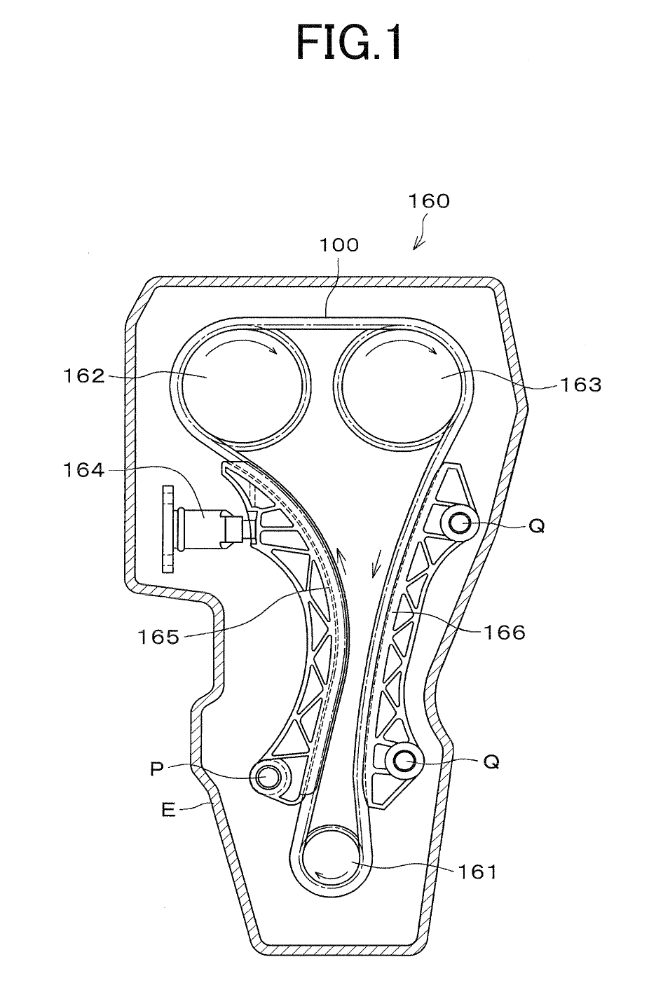

FIG. 1 shows a timing drive 160 in a dual overhead cam (DOHC) automobile engine, which is an example of an apparatus in which a chain according to the invention can be used. The chain 100 is an endless chain, driven by a crankshaft sprocket 161, and in driving relationship with two camshaft sprockets 162 and 163.

A pivoted chain guide 165 is in sliding engagement with the slack side of the chain, i.e., the part of the chain that travels from the crankshaft sprocket 161 to camshaft sprocket 162. Guide 165 is pivoted on a bearing P, which can be a mounting bolt or mounting pin fixed to a part of engine E. Guide 165 is biased against the chain 100 by a tensioner 164 so that a shoe of the guide is held in sliding contact with the chain. The guide thereby maintains adequate tension in the chain, prevents vibration, and also limits lateral swinging movement of the chain in directions perpendicular to the plane defined by the path of circulating travel of the chain.

A fixed chain guide 166, which is fixed to the engine E by mounting pins Q or other suitable fastening means, is in sliding engagement with the tension side of the chain, i.e., a part of the chain that travels from camshaft sprocket 163 toward the crankshaft sprocket 161. This fixed guide also guides the chain and restricts its path of travel.

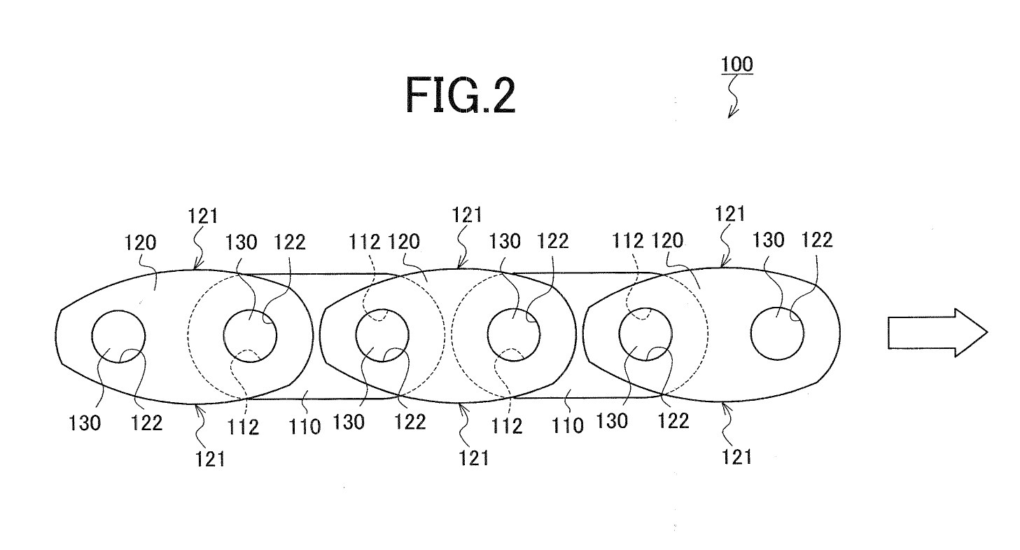

As shown in FIG. 2, the chain 100, according to a first embodiment of the invention, is composed of a plurality of inner link plates 110 and a plurality of outer link plates 120. The inner link plates are arranged in laterally opposed pairs forming inner links, and the outer link plates are likewise arranged in laterally opposed pairs forming outer chain links. The inner and outer links are disposed in an alternating, overlapping relationship along the length of the chain. Each of the inner link plates has a pair of bushing holes 112, and each of the outer link plates has a pair of pin holes 122. Connecting pins 130, which are fixed to the pin holes 122 of the outer link plates, extend rotatably through the bushing holes 112 of the inner link plates, thereby flexibly connecting the links.

The chain can be a rollerless bushing chain, in which the connecting pins 130 extend rotatably through bushings that are fitted to the holes 112 of the inner link plates 110. Alternatively, the chain can be a roller chain, in which rollers surround the bushings and are rotatable thereon.

Upper and lower edges 121 of the outer link plates 120 are convex, and each such convex edge is in the form of a continuous curve in a plane to which the direction of chain travel is parallel. One such convex edge of each outer link plate comes into sliding contact with the chain guides. The upper and lower edges of the inner link plates 110 are closer together than the upper and lower edges of the outer link plates so that the inner link plates do not come into sliding contact with the guides.

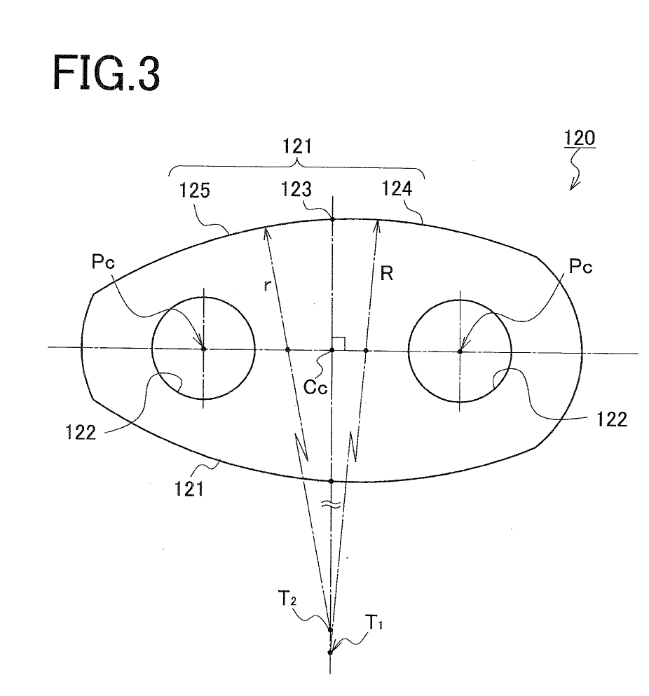

As shown in FIG. 3, the distances from the apex 123 of the convex edge 121 to the centers Pc of the front and rear pin holes 122 are equal, so that the apex is located on a line perpendicular to a line connecting the centers of the front and rear pin holes and intersecting the connecting line at a point Cc midway between the centers Pc of the pin holes.

The convex edge 121 that comes into sliding contact with the guides is composed of a front portion 124 forward of the apex 123 in relation to the direction of chain travel. This front portion 124 is in the form of a circular arc having a radius R and centered on a point Ti on the perpendicular line that extends through point Cc. A rear portion 125 on the rear side of the apex 123 is in the form of a circular arc having a radius r centered on a point T2 on the perpendicular line extending through point Cc. The radius R of the front portion 124 is to be larger than the radius r of the rear portion 125.

The shapes of the outer link plate 120 in the drawings are exaggerated to explain the shape of edge 121. The radii R and r may be actually so large that the convex edge 121 is nearly straight.

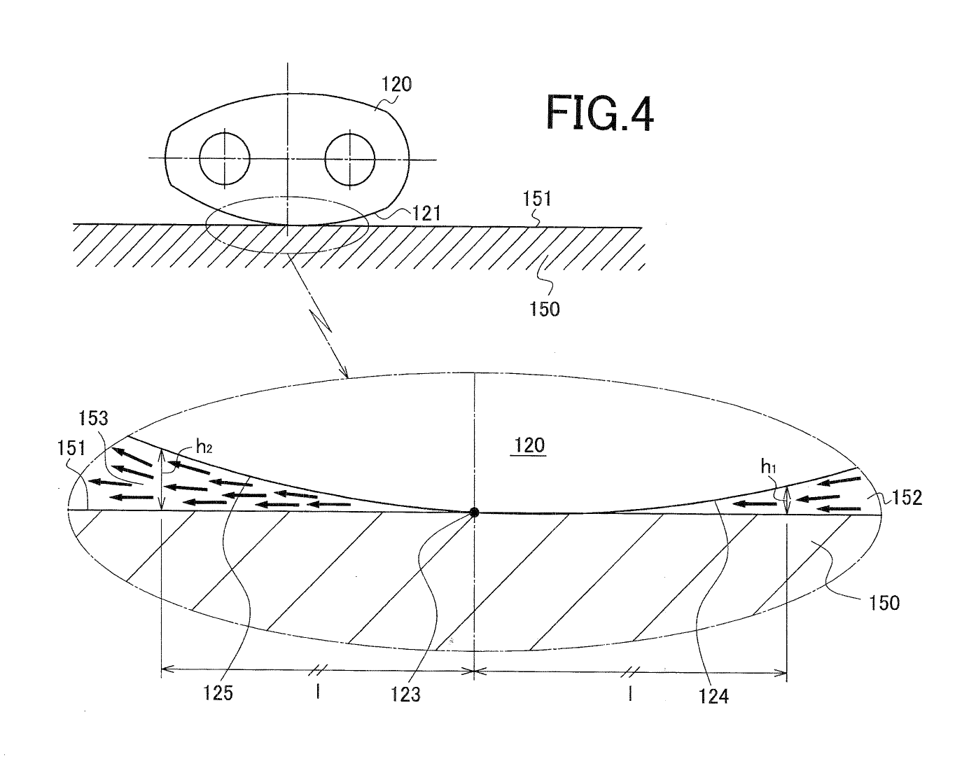

Referring to FIG. 4, when the chain travels toward the right while its convex edge 121 is in sliding contact with a surface 151 of a guide shoe 150, a wedge-shaped front space 152 is formed between the front portion 124 of the convex edge 121 and surface 151 of the guide shoe 150. As the chain travels, a wedge-film effect is brought about and Couette flow is generated in the vicinity of the apex 123 so that dynamic pressure is generated in lubricant between the edge 121 of the link plate and the shoe surface 151, reducing sliding contact resistance.

A wedge-shaped rear space 153 is also produced also behind the apex 123 between the rear portion 125 of edge 121 and the shoe surface 151. Here, because the radius R of the front edge portion 124 is larger than the radius r of the rear edge portion 125, the volume per unit distance of the rear space 153 is larger than that of the front space 152, and rate of the Couette flow in the rear space 153 is smaller than that in the front space 152. The effect of the lubricant in the vicinity of the apex 123 is enhanced, the lubricant film between the guide surface 151 and the apex 123 is less susceptible to interruption by turbulence or vibration, and reduced wear of the mutually contacting parts of the chain and the guides can be realized.

Because the radius r of the rear portion 125 is smaller than the radius R of the front portion 124, and because the gap h2 between the rear portion 125 and the guide surface 151 at a location spaced from the apex 123 by a distance I is larger than the gap h1 between the front portion 124 and the guide surface 151 at the same distance from the apex, the part of the rear portion 125 which is so close to the guide surface as to be significantly affected by resistance due to the viscosity of the lubricant is shortened.

The chain according to the second embodiment of the invention has the same construction as that of the chain of the first embodiment, and differs from the first embodiment only in the shape of the outer link plates.

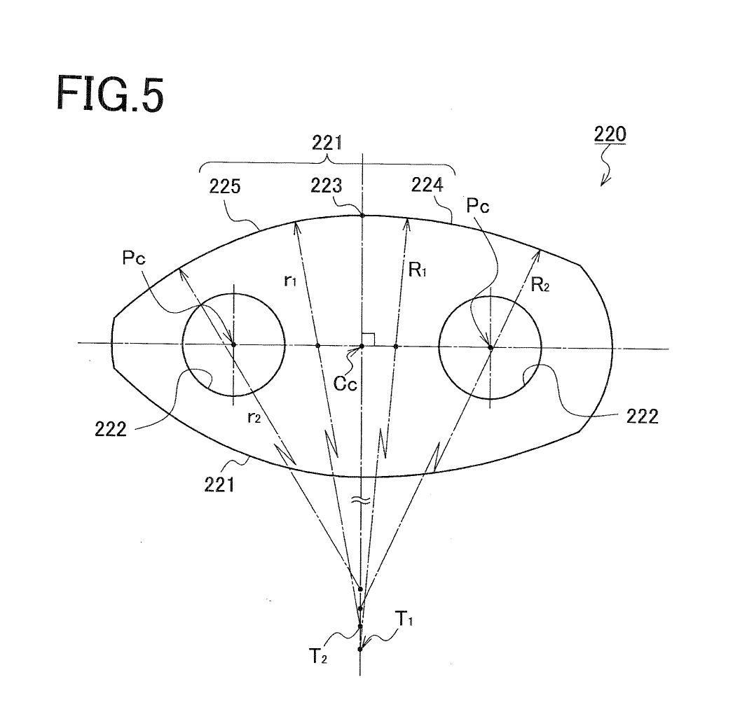

As shown in FIG. 5, in an outer link plate 220, the distances from the apex 223 of the convex edge 221 to the centers Pc of the front and rear pin holes 222 are equal, so that the apex is located on a line perpendicular to a line connecting the centers of the front and rear pin holes and intersecting the connecting line at a point Cc midway between the centers of the pin holes.

In the immediate vicinity of the apex 223, the front portion 224 of edge 221, i.e., the portion on the front side of the apex in relation to the direction of chain travel, has a radius R1 centered on a point Ti on the perpendicular line passing through point Cc. The radius of curvature of front portion 224 continues to decrease with increasing distance from the apex, through a shorter radius of curvature R2 at a location close to the front end of the link plate. The curvature of the front portion 224 is substantially that of a cycloid, a curve having a continuously changing radius of curvature.

The rear portion 225 is also has a substantially cycloidal shape, having, near the apex, a radius r1 centered on a point 12 on the perpendicular line through point Cc in the vicinity of the apex 223, and having a continuously decreasing radius with increasing distance from the apex, through a shorter radius of curvature r2 at a location close to the rear end of the link plate. In this embodiment, the radius of curvature of edge 221 at any given distance forward of the apex is greater than the radius of curvature at the same distance rearward of the apex.

The outer link plate 220 operates in the same manner as the outer link plate of the first embodiment. As the chain travels over a guide surface, wedge-film effect is brought about, and Couette flow is generated in the vicinity of the apex 223, so that the lubricant generates dynamic pressure and reduces sliding contact resistance. The effect of the lubricant in the vicinity of the apex 223 is enhanced, the lubricant film between the guide surface and the apex 223 is less susceptible to interruption by turbulence or vibration, and reduced wear of the mutually contacting parts of the chain and the guides can be realized.

Because the rear portion 225 has a cycloidal shape, the gap between the rear portion 225 and the guide surface at any given distance from the apex 223 can be larger than the corresponding gap in the first embodiment, and the length of the part of the rear portion that is significantly affected by resistance caused by lubricant viscosity is further reduced.

Although the link plates of the first and second embodiments shown in FIGS. 2 through 5 have upper and lower convex edges, 121 and 221, that are symmetrically disposed on opposite sides of a line connecting the centers of their pin holes, it is possible to realize advantages of the invention in an embodiment in which only one edge is convex and slidable on a guide. For example a link plate having only one convex edge shaped in accordance with the principles of the invention can be a toothed link plate of a silent chain. In such a case, some or all of the link plates of the chain can have convex backs shaped in accordance with the principles of this invention as described above.

In another alternative embodiment, both the outer link plates and the inner link plates of a chain can have convex edges shaped in accordance with the principles of this invention.

The design and fabrication of the link plate can be facilitated by forming the front portion of the guide-contacting edge as a circular arc having a constant radius, and by forming only the rear portion with a cycloidal shape. The design and fabrication of the link plate can also be facilitated by forming the substantially cycloidal portions of the guide-engaging edge as a series of connected short circular arcs having progressively decreasing radii of curvature. In this case, the shape departs slightly from that of a conventional cycloid, but exhibits the same effects. Other minor departures from a mathematically defined cycloidal shape can also be taken without a material adverse effect on the performance of the chain.

With the invention, it is possible to reduce the sliding contact area between the link plate edges and the guide surfaces, and to reduce the sliding contact resistance by generating dynamic pressure in the lubricant. With the invention it is possible to optimize the shape of the portion of the link plate edge forward of the apex to take advantage of the effects of Couette flow and dynamic pressure in the lubricant, and at the same time reduce the resistance caused by lubricant viscosity in the spaces to the rear of apices of the link plates. The invention also makes it possible to optimize the surface pressure in the vicinity of the apex so that it corresponds to dynamic pressure and lubricant viscosity, so that the sliding contact resistance and the rate of wear of the relatively sliding parts can be more effectively reduced.

What is claimed is:

1. An elongated, low-friction transmission chain, comprising:
a plurality of links flexibly interconnected by parallel connecting pins extending through front and rear pin holes in each of the plates, and in which each link comprises a plurality of link plates at least some of which have at least one edge for sliding contact with a guide member;
wherein said at least one edge has a continuous convex curvature in a plane to which the connecting pins extend in perpendicular relationship;
wherein an apex of said convex edge is located at a position equidistant from centers of the front and rear pin holes of the plate having said convex edge; and
wherein said convex edge has different curvatures on front and rear sides of said apex.

2. The chain according to claim 1, wherein said edge has a front portion ahead of said apex in relation to the direction of chain travel, and a rear portion behind said apex in relation to the direction of chain travel, and wherein the radius of curvature of said convex edge is greater in said front portion than in said rear portion.

3. The chain according to claim 1, wherein said edge has a front portion ahead of said apex in relation to the direction of chain travel, and a rear portion behind said apex in relation to the direction of chain travel, and wherein the curvatures of both the front portion and the rear portion are in the form of circular arcs each having a constant radius.

4. The chain according to claim 1, wherein said edge has a front portion ahead of said apex in relation to the direction of chain travel, and a rear portion behind said apex in relation to the direction of chain travel, and wherein the curvatures of both the front portion and the rear portion are cycloidal.

5. The chain according to claim 1, wherein said edge has a front portion ahead of said apex in relation to the direction of chain travel, and a rear portion behind said apex in relation to the direction of chain travel, and wherein the curvature of at least one of said front and rear portions is in the form of a circular arc having a constant radius, and the curvature of the other of said front and rear portions is cycloidal.
